(19) United States
(12) Patent Application Publication
(10) Pub. No.: US 2006/0267799 A1
(43) Pub. Date: Nov. 30, 2006

(54) Parking detector - a system and method for detecting and navigating to empty parking spaces utilizing a cellular phone application

(76) Inventor: Ehud Mendelson, Coral Springs, FL (US)

Correspondence Address: EHUD MENDELSON;GAMBA GROUP LLC, 11190 HERON BAY BLVD., SUITE 916, CORAL SPRINGS, FL, 33076, US

(21) Appl. No.: 11/415,665

(22) Filed: May 2, 2006

Related U.S. Application Data
(60) Provisional application No. 60/678,934, filed on May 9, 2005.

(51) Int. Cl. G08G 1/14

(52) U.S. Cl. 340/932.2

(57) ABSTRACT

The parking detection system method described herein could guide people around urban environments, detect guide and navigate them to empty parking spaces, add-on to the car-based navigation systems that are popular today and or to the portable phone. We have focused on the task of detecting and navigating even in situations in which Global Positioning Systems (GPS) cannot provide this information, such as when the person is indoors or in crowded urban areas where there is no line of site to the GPS satellites. The parking information will be received directly from RF sensors and will display as a floating overlay on the existing cellular phone as Bluetooth application making the cellular phone a parking detector.

### FIELD OF THE INVENTION

This invention is directed generally to the field of “location based navigation” and, more particularly, to such method to be used in a cellular phone wireless application for detecting and navigating to empty, available parking spaces.

### BACKGROUND OF THE INVENTION

Introduction to Location Based Services:

Location based services are rapidly expanding. Outdoor location technologies are mainly based on GPS technologies. GPS does not perform properly indoors, and is not adequate. Recently, as a result, indoor location systems are appearing on the market.

The need for a system such as ours arises from various market segments and applications. One example in the market is the “Car Navigator” that uses integrated positioning and navigation systems based on GPS receivers as the primary positioning technology. Subsequent to the events of September 11^{th} the Federal government mandated that GPS capability be built in to all cellular phones.

However, the fact that uninterrupted satellite reception is not possible in many situations is a major limitation of GPS based systems. Densely populated areas and radio-frequency-signal shadowed locations, such as urban centers (a.k.a. “urban canyons”), generally do not allow proper operation of GPS, yet it is in these locations that the need is greatest.

There is a clear need for a cost effective system that maintains performance indoors, in urban canyons and in city centers. Another important issue is that GPS itself is susceptible to jamming and other man-made interference.

Description of GPS System.

The Global Positioning System (GPS) is a satellite-based navigation and time transfer system developed by the U.S. Department of Defense. GPS serves marine, airborne and terrestrial users, both military and civilian. Specifically, GPS includes the Standard Positioning Service (SPS) that provides civilian users with 100 meter accuracy as to the location or position of the user. It also serves military users with the Precise Positioning Service that provides 20 meter accuracy for the user. Both of these services are available worldwide with no requirement for any local equipment.

View of GPS Limitations:

First limitation of GPS is that upon activation the GPS receiver scans for signals from the GPS satellites. The unit must locate and receive signals from at least four satellites to be able to determine its location. This process of locating the satellites, receiving the data and achieving a position fix can take several minutes. This delay is problematic for many GPS applications.

Second limitation of GPS is that the receiver needs a clear view of the sky to successfully receive signals from the satellites, again under unfriendly RF conditions such as inside buildings, or in “urban canyons” or in the shadows of high buildings, the GPS suffers from multi-path effects and therefore shows poor performance, or none at all.

Third Limitation—limited accuracy: There is a problem of limited accuracy of the civilian GPS signal. While knowing your position to within 50 to 200 feet anywhere on the planet is a major technological feat, it is still not accurate enough, to locate and navigate to an empty parking space, where each space measures about 10 feet, and most parking garages are located where the GPS cannot work effectively.

Existing navigation systems, such as in-car navigation systems and new mandatory GPS equipped cellular phones, are based on GPS and have the aforementioned limitations.

Another significant factor adding to the limitations of the GPS based systems is the important role of map production; normally a driver, requires a map to be as detailed and as up-to-date as possible. The existing maps used by the GPS based systems provide limited detail and are not able to reflect changes on a real time basis. The recent introduction of imagery services, such as Google Earth and its competitors, that are offered as an enhancement to GPS at a fee, still provide out of date information, with the unsatisfactory result that users encounter road changes and area development not shown on the maps and imagery.

In this modern age when urban development is exploding, the lack of details and updates of the topographic maps and satellite images is critical; additionally and importantly, indoor location maps are not available for the GPS navigation systems.

Application:

In general, our system is based on applying machine-learning techniques to the task of inferring aspects of the user's status from a stream of input from sensors.

We have focused on indoor navigation, or navigation in crowded urban areas, where GPS based systems, due to lack of access to satellites or the GPS limitations detailed previously, cannot achieve the required results.

We have focused on the task of interactively guiding the user to a desired indoor destination. Our system has a minimal need to know the user's location to carry out this task.

Examples of Indoor Applications:

The user may wish to locate a specific store in a shopping mall, or a particular aisle in a department store.

The user may wish to locate a specific conference room in a convention center, or a point of interest in an amusement park or a point of interest in a museum.

The user may be looking for a train location in a station, or stops in a large subway or underground train system.

Or they may just wish to locate an available parking space.

Parking Detection and Navigation Application:

There is no easy way to find empty parking spaces in a busy city. Drivers usually either waste time driving around the area looking for an open space, or abandon the search, paying a large fee to park in a garage, or to use a valet parking service. It would be very advantageous to be able to provide a driver looking for a parking space with Parking Detector, capable of identifying available, empty parking spaces in the driver's proximity, and with a competitive edge over someone without such a Parking Detector.

Every working day 105 Million drivers are looking for a place to park!

It is estimated that 40% of urban traffic is due to this “Search for parking a space.”

The top 85 US cities face increasing congestion problems because of steady population growth and the lack of locations to build additional parking.

Traffic congestion is estimated to cost travelers in the 85 biggest US cities a whopping 3.5 billion hours a year, more than 50 hours a year per driver in major cities, almost a week of work.

Traffic and traffic congestion are two main reasons for pollution, and vehicle emissions contribute significantly to the “green house effect”.

In our society where time, convenience and comfort are precious commodities, parking is a major perk, or major headache.

Our “Parking Detection System” provides the answer to the most demanding need of any driver, “Where can I park?”

With the implementation of our system, navigating and detecting available parking spaces will become part of the information revolution.

Our system, a network of self organizing sensors will enable municipalities and other parking authorities to easily identify, exploit and manage revenue opportunities while at the same time providing better service at a lower operating cost.

With our system, drivers will save time, reduce the frustration of hunting for parking spaces and also will save money on gas usage and car maintenance costs.

By using and modifying existing technology, our system will integrate easily with other transportation and communication systems.

Reference to Prior Arts:

Despite the problems encountered by vehicle operators at parking facilities, most existing parking monitoring systems focus on collecting information for management. Some prior art systems employ sensors at entrances and exits to parking facilities or sections of such facilities (See U.S. Pat. No. 3,130,298 to Schwarz). These sensors trigger a counter to determine the number of cars in the monitored area by subtracting the number of cars leaving the area from those that have entered. At least one of these monitoring systems also engages a timer to determine the aggregate usage time of the facility by summing the total time from the entry of the cars to their departure (See U.S. Pat. No. 3,867,615 to Sioufi). These systems profess to be useful in monitoring the usage of the parking facility.

Prior Art curbside parking monitoring systems have been coupled with centralized signals which indicate general areas where drivers may find a curbside parking space (See U.S. Pat. Nos. 3,114,128 and 3,166,732 to Ljungman). Upon sensing that a space adjacent a parking meter is vacant, the system signals drivers from a signpost at an intersection of the city block along which the parking space is vacant. The signal appears in a binary yes or no stating that one or more parking spaces are available in the adjacent block-long area. However, because the driver seeing a parking available signal is not advised of the number and specific location of parking spaces that are available in that block, the vehicle operator may proceed to the indicated location to find that a single available space has already been occupied or that the space will not accommodate his vehicle. In either situation, the binary availability signal may lead the vehicle operator on a fruitless quest.

Another monitoring system for a parking facility compares the number of cars within a designated area (determined by counting cars entering minus cars departing the area) with the number of spaces within that area. When the net number of cars equals the number of spaces, the system registers that the area is completely full and signals drivers to proceed to the next area (See U.S. Pat. No. 3,158,836 to McCauley). Unfortunately, such systems again only yield a binary yes or no signal to the drivers. Even if an area contains only one available space, even if the space is obstructed, will not accommodate the driver's car, or is otherwise undesirable, a driver still will be lead to that area.

These prior art systems are of only limited help to vehicle operators and do not resolve many concerns associated with parking an automobile.

U.S. Pat. No. 5,293,163 to Kakihara, et al., entitled, “Navigation Apparatus for Vehicles”, describes a system for finding garages or other parking facilities with available parking spaces. It provides for the display of available parking information in map format. This vehicle navigational system patent does not address the problem of locating available on-street parking. Instead, it addresses the problem of locating parking lots with available spaces. Parking lots in congested city areas are not very cost effective, and they may not be in close proximity to the driver's destination. The patent does not direct drivers directly to an available metered space, a less expensive alternative, but simply to a large parking lot where they will have to search for an available space. In addition, the Kakihara map display only directs the driver as far as a parking facility. The driver still must navigate around the parking facility to locate an available space.

U.S. Pat. No. 5,432,508 to Jackson, entitled, “Technique for Facilitating and Monitoring Vehicle Parking”, describes a scheme for finding available parking spaces in garages and other parking facilities. It provides for the display of available parking information at the entrance of a garage and makes a provision for a light source to be mounted above a parking space to indicate its availability. Remote access to the data is provided by a dial-up telecommunication interface. Because the technique described operates over a wireline medium, it does not lend itself to being easily deployed in a wide area. Also, because parking information is never provided to any device within a vehicle, drivers still need to navigate through a garage to locate available spaces.

Parking meters with sensors, parking meters with transmitters, and navigational equipment receiving and displaying external information are well known in the art. U.S. Pat. No. 5,442,348 entitled, “Computerized Parking Meter”, for example, describes a parking meter utilizing an ultrasonic transducer to detect when a car is occupying a parking space. Similarly, U.S. Pat. No. 5,454,461, entitled, “Electronic Parking Meter and System”, describes a parking meter utilizing a sonar transducer for parked vehicle detection and radio means for receiving billing information.

At present, there is no on-board vehicle navigational system that delivers accurate and real time parking space information directly from the vehicle or ether portable phone application upon entering a specific geographic area.

Accurate Navigation

U.S. Pat. No. 5,504,482 to Schreder describes an automobile equipped with an inertial and satellite navigation system as well as a local area digitized street map. The main use of this patent is for route guidance in the presence of traffic jams, etc. Schreder describes how information as to the state of the traffic on a highway can be transmitted and utilized by a properly equipped vehicle to change the route the driver would take in going to his destination. Schreder does not disclose sub-meter vehicle location accuracy determination

Vehicle Location

U.S. Pat. No. 5,272,483 to Kato describes an automobile navigation system. This invention attempts to correct for the inaccuracies in the GPS system through the use of an inertial guidance, geomagnetic sensor, or vehicle crank shaft speed sensor. However, it is unclear as to whether the second position system is actually more accurate than the GPS system. This combined system, however, cannot be used for sub-meter positioning of an automobile.

U.S. Pat. No. 5,383,127 to Shibata uses map matching algorithms to correct for errors in the GPS navigational system to provide a more accurate indication of where the vehicle is or, in particular, on what road the vehicle is. This procedure does not give sub-meter accuracy. Its main purpose is for navigation and, in particular, in determining the road on which the vehicle is traveling.

U.S. Pat. No. 5,416,712 to Geier, et al. relates generally to navigation systems and more specifically to global positioning systems that use dead reckoning apparatus to fill in as backup during periods of GPS shadowing such as occur amongst obstacles, e.g., tall buildings in large cities. This patent shows a method of optimally combining the information available from GPS even when less than 3 or 4 satellites are available with information from a low-cost, inertial gyro, having errors that range from 1-5%. This patent provides an excellent analysis of how to use a modified Kalman filter to optimally use the available information.

U.S. Pat. No. 5,606,506 to Kyrtsos provides a good background of the GPS satellite system. It discloses a method for improving the accuracy of the GPS system using an inertial guidance system. This is based on the fact that the GPS signals used by Kyrtsos do not contain a differential correction and the selective access feature is on

Locating a vacant parking space is an ordeal that causes frustration for many commuters. Even if a commuter pays to enter a parking lot, valuable time is consumed searching for a parking space within the parking lot. It seems that parking lots that service hospitals, airports, mass transit stations, entertainment forums, shopping malls and the like are always the most crowded, when time is the most crucial. As urban and suburban regions become more populated, finding a vacant parking space will become increasingly difficult for commuters.

U.S. Pat. No. 5,910,782 to Schmitt et al. ('782 patent) discloses a system for finding available on-street parking using an on-board vehicle navigation system and parking meters equipped with sensing devices. According to the '782 patent, real time metered parking space information can be accessed from a central location or directly by a vehicle, upon entering a specific geographic area.

U.S. Pat. No. 5,940,481 to Zeitman ('481 patent) discloses a parking management control system used to report parking, monitor parking and reserve parking spaces. According to the '481 patent, a user reports parking in a particular parking facility to a central control unit using a personal non-dedicated mobile communications device. The central control unit then confirms whether parking in the particular parking facility is authorized or not. The central control unit also generates a report indicating which parking facilities are supposed to be vacant for law enforcement officials so that unauthorized parking can be ticketed. The '481 patent also discloses that a user can reserve a desired parking facility by selecting a desired parking facility from a map provided from the central control unit. If a potential user, other than the registered user, communicates a request to park in the reserved parking facility, the control unit transmits a response to the potential user indicating that the parking facility is reserved and not authorized for use.

At present, however, no prior art device utilizes the capabilities to display a real-time representation of available parking spaces directly from the sensors without a central system; and without using a GPS based system directly to the “user” driver. Also most of systems are designed for parking garages or metered areas whereas our system is for any places designated as a parking space, either in-door, out door, public or private. Our system is based on sensors that detect the empty space whereas most of the others detect the car.

Our system automatically detects a signal directly from the sensors, no communication needed. Other systems must have bandwidth available, over which to send a request to a central system, or to a database, and then must wait for a response. This takes time!

Even if the other systems have bandwidth, they still based on the existing search concept where under the user submits a query, searches and awaits for the response. All impractical while driving in traffic. Our system provides the information automatically, without submitting any query, and the response is according to the user's location.

Again, most of the existing prior arts are based either on a GPS based system or the existing car navigator, that depends on a GPS too.

And the existing mapping that these systems use has the same limitations described previously and is impractical.

A system that requires a driver to interface with the internet can only be used for remote planning and not while a driver is navigating through traffic and looking for a parking space.

We believe that our system method bridges the gap between the GPS based navigation and the existing in car systems and provides a complete solution.

Project in Parking:

XM Radio in conjunction with partners NU-Metrics inc. and infoGation, introduce a “parkingLink” capability concept.

The system shows the actual number of spaces available at designated parking facilities on vehicle navigation map, and uses color-keyed icons to indicate the percentage availability of the facility. The driver still must navigate around and inside the parking facility to locate an available space.

Parkingcarma from ACME Innovation, that is based on sensors that count the cars driving in and out of the parking facility and inform drivers via a cell phone call, or by an electronic sign, or over the internet, regarding the availability in the parking garage. The driver still must navigate around and inside the parking facility to locate an available space.

Other parking projects exist but they do not approach our innovation in ability to deliver a complete solution to the parking problem. Other projects address the issue from the perspective of a parking garage and do not consider street parking, nor are they really concerned to facilitate the location of an empty space inside their garage. They do not provide the driver with the ability to compare prices in the vicinity. Nor do other projects contemplate the concept of a parking detector with a direct communication between the sensors and the “user” driver in real-time.

Indoor Location Technologies.

Various technologies are used for wireless indoor location. These may be classified in two aspects:

The algorithm—i.e. the method of location used.

The physical layer—i.e. the wireless technology used to communicate with the mobile device.

Location Methods

The methods typically used in indoor location are “borrowed” from the outdoor GPS location methods inventory. Specifically, four types of methods are used indoor:

Proximity Detection (PD), Received Signal Strength (RSSI), Time of arrival (TOA), and Angle of Arrival (AOA).

Proximity Detection (PD)

This method relies upon a dense grid of antennas, each having a well-known position. When a mobile is detected by a single antenna, it is considered to be collocated with it. When more than one antenna detects the mobile, it is considered to be collocated with the one that receives the strongest signal. This method is relatively simple to implement. It can be implemented over different types of physical media. In particular, IR and RFID are based on this method.

Triangulation

Triangulation takes PD a step further, in the sense that it is based on measuring the signal level measurements from each antenna (possibly by using a triangulation mechanism), with respect to each mobile device. Following that, mobile is located by using a triangulation algorithm.

Like the PD method, triangulation is relatively simple to implement.

Time of Arrival (TOA)

TOA is based on triggering the mobile devices to respond, and measuring the time it takes for the response to flyback to the antenna. The elapsed time represents the distance between the two. By using distances from few antennas, a mobile's position can be triangulated. TOA is considered to be the most accurate method, because multipath effects can be filtered out. Yet, it is considerably more complex to implement, as it requires a modification to the hardware on the mobile side, as well as special modifications on the antenna side.

Angle of Arrival (AOA)

AOA is based on finding the direction of maximal signal intensity for each antenna-device pair. By finding the intersection of few such direction vectors, a mobile's position can be estimated

AOA is considerably less accurate than TOA, due to limited angular resolution and the fact that indoor much of the signal is reflected. Also, AOA antennas are more complex, as they require multi-section, highly directional antennas, and multiple RF circuitry.

WLAN (IEEE 802.11b)

This midrange wireless local networking standard, operating in the 2.4 GHz ISM band, has become very popular in public hotspots and enterprise locations during the last few years. With a typical gross bitrate of 11 Mbps and a range of 50-100 m, IEEE 802.11b is currently the dominant local wireless networking standard.

It is therefore appealing to use an existing WLAN infrastructure for indoor location as well, by adding a location server. Such solutions do exist in the market, providing an accuracy of ˜2 m.

One limitation of such systems is the fact that WLAN tags are relatively bulky and power hungry. Thus, such locators are mainly useful to locate WLAN enabled instruments, such as portable computers.

Note that in WLAN, antennas are actually part of access points (APs), through which devices communicate with the access network. This is also the case with Bluetooth.

Bluetooth (IEEE 802.15)

Bluetooth is a newer wireless local networking standard, that operates in the 2.4 GHz ISM band. Compared to WLAN, the gross bitrate is lower (1 Mbps), and the range is shorter (typically 10-15 m, though there are Tags with a range of over 300 feet). On the other hand, Bluetooth is a “lighter” standard, highly ubiquitous (embedded in most phones, PDAs, PC peripherals, etc.) and supports, in addition to IP, several other networking services. Notably, Bluetooth supports serial port emulation, voice, and various types of object exchange.

Bluetooth tags are small, pocketsize transceivers.

Every Bluetooth device's tag has a unique ID. This ID can be used for locating the tag.

### SUMMARY OF THE INVENTION

In accordance with the present invention, these are our project's characteristics:

Our system is a navigation method based on the following unique characteristics:
In an indoor or outdoor navigation situation our sensor net, and sensor tags, replace the satellite in a GPS based system, to provide the user with the information and directions needed to reach the destination (a parking space).

Our innovation has three major parts:
The Parking Detector, the special method used to display the data and the sensors.
It is not a location and tracking system as offered by other systems.

The sensors, that are arranged in an RF sensor network, detect when a parking space is empty.

A very small RF sensor installed in each parking space, or any place designated as parking space be it at a parking meter, parking garage, street parking, inside or outside, public or commercial. The sensor can be RFID (long range type), or a long range Bluetooth, or a wifi or any RF type. The sensor broadcasts a unique ID by wireless that identifies the location of the parking space (the unique parking ID, address, and price). The sensor recognizes the vacancy and broadcasts it to be picked up by the Parking Detector, viz the cellular phone application.

The system can generate a parking ticket (e.g. for a parking garage) with the exact available parking space. Additional information screens can be installed at the corners of parking lines, guiding drivers to locate available parking space. These lens/screens can be installed on street corners, or in open parking garages or on parking meters to provide extra assistance to drivers.

The Parking Detector.

The Parking Detector, (TM in a process), cellular phone application.

The user will receive the data broadcast by the parking sensors in the area via the interface with a cellular telephone utilizing the cellular phone's Bluetooth capability. It is important to note that no cellular communication or internet or database access is needed and that any Bluetooth enabled device will operate our Parking Detector application as a stand alone device. Our system will interface with existing in-car navigation systems

The Display Method.

The display method is our unique way to bridge existing devices like cellular phones, in-car navigation and other Bluetooth devices. We provide our overlay add-up display method over the existing navigation system, as a real-time floating overlay omni directional circular display to overcome the limitations of GPS based systems and the existing mapping systems.

The overlay add-up device/display works without mapping, a VOR like add-up display shows the available parking spots in the immediate area without the need for a mapping background;

mapping can be offered as an additional service. No regenerating of mapping is necessary.

Our navigation system method will enable remote planning based on downloaded local floor-plans, or local navigation, when the location's floor plan can be downloaded at the destination. An example of this would be at the entrance of a parking garage, shopping mall, department store, amusement park, museum or the down town area of a city.

Our system is based on a network of sensors that can be deployed anywhere, not just in parking lots or parking garages. The system is accurate to within 10 feet, significantly better existing navigation systems and GPS.

The system can work inside a building whereas GPS cannot. Local detection is obtained via popular Bluetooth interface. The system provides information about each parking space's availability, including information about the price and type of space, for example: regular, handicap etc.

By providing the ability to locate a parking space in advance using a Bluetooth enabled device, or a cell phone with our parking detector application the system overcomes the anxiety of “Where will I park” and also facilitates finding the car later via the RTP (Return to Parking) feature.

The system has the capability to perform all the functions of a parking meter and can become the “Next generation parking meter”.

Automatic payments can be handled via systems such as “Sun Pass” or by an established account.

The system can allow established account/card holders (e.g. Sun Pass members) the option to make a parking reservation in advance.

Our system can be an attractive additional feature for cities that intend to deploy WIFI.

In case of an emergency, or in a security situation, the system can provide authorities with information about a parked car and can serve as security add-on.

Using the system, municipalities and parking operators can manage their facilities better, compile helpful statistics and increase inventory control of the parking spaces resulting in better service and increased availability.

The system eases navigation to a parking space, without a navigation map or GPS. Mapping background can provided as an additional feature on our system.

The system provides “local” detection as well as “remote” detection. The system allows easy interface with existing networks. The system saves gas, time, money and eases global warming by reducing the time spent searching for a space to park.

Our parking detection method is unique. We base our system on RF sensor tags with interface to Bluetooth enabled devices This feature allows detection inside a building where GPS cannot work, as well as outside, with the capability to guide the driver to within 10 feet of the destination (i.e. a parking space), significantly better than any other navigation and GPS based systems on the market.

Our Bluetooth/RF sensor is based on a long range version of the popular short distance communication. This unique feature affords the user the ability to plan ahead where to park by obtaining data directly from the parking sensors and from remote by accessing the inventory of available parking spaces at the destination from data broadcast by Parking Guide.

One problem with In-Car navigation and GPS mapping is that they cannot guide the user to closer then 50 to 200 feet, and only in open places, whereas our system can provide accurate directions to within 10 feet, and to pinpoint the available parking space.

Our system will be a challenge to the navigation providers as well as the GPS providers as they cannot provide mapping or navigation inside the parking garage or lot, and in street parking the GPS/Navigation map cannot accurately locate the parking space.

Utilizing our innovation the available parking spaces in the vicinity around the “user” car are displayed on a floating overlay using either a cellular phone application or a stand alone device or an existing installed navigation system with or without any mapping.

The recent introduction of imagery services, such as Google Earth and its competitors, that are offered as an enhancement to GPS at a fee, still provide out of date information, with the unsatisfactory result that users encounter road changes and area development not shown on the maps and imagery.

Navigation using the mapping or floor-plan of a location can be offered as an additional service, although it may not be necessary or needed, as the “user” will have an easy way to figure out the distance and the direction to the empty parking spaces without GPS or any mapping!

The option of downloading a floor-plan can be exercised either remotely or locally.

The parking sensors broadcast their signal continuously and any of our parking detectors will detect them and display the data on the user's device in an easy to understand method.

With our innovation you have the parking information that you want, when you want it, where you want it . . . (and at an affordable price)

Once you are in the vicinity of your destination and you switch on your detector, you will automatically receive the parking information along your route and in all directions around you. No further action is required, there is no need to send a request or to access the internet/web or log on and search a database or central system.

Other systems must have bandwidth available, over which to send a request to a central system, or to a database, and then must wait for a response. This takes time!

Even if the other systems have bandwidth, they still based on the existing search concept where under the user submits a query, searches and awaits for the response. All impractical while driving in traffic. Our system provides the information automatically, without submitting any query, and the response is according to the user's location.

Our unique approach does not need an internet bandwidth or cellular communication at all.

And as a result there is no delay or waiting for communication and access time, the communication is instantaneous, directly between the sensors and the user's Parking Detector.

The empty parking spaces will be displayed inside a graphical real-time floating omni-directional circular display in such way that the “user” will intuitively determine the distance and the direction to the empty parking spaces.

Additionally, each parking space will be shown with a simple color-code to identify the type of the parking space, e.g. regular of handicap.

Each color-coded display of an empty parking space can be accessed to obtain complete information about the parking space, e.g. price and automatic waypoint information.

Each circular line represents 50 feet in distance from the user's car. This makes it easy for the user to determine the distance to the parking space.

The ability to operate our innovation using our application on a cellular phone, the Parking Detector, with no need for cellular connection, or on any stand alone Bluetooth enabled device, means the user does not need a built-in navigation system in the car.

For the next generation Parking Detector the parking data will be displayed as a clear, heads-up display on the driver's windshield.

More over, our innovation can solve the “RTP” (Return to parking) problem, where many forget where they parked their car. The system has an option to save the location on the “cellular phone—parking detector” application, that will make it easy to locate the parked car.

Our solution is designed for global use and is not limited to parking garage or parking metered spaces, our innovation can be implemented anywhere, in any place designated as parking space! It is our plan that in the future all new construction designated for parking spaces will have the sensor tags included in the design.

With our innovation, the next generation parking meter can be . . . no meter at all, with automatic recognition and automatic payments.

The ability to make “Remote” reservations will be future option.

We integrated the parking system as part of our NAV4 concepts where it will provide complete solutions for local navigation in an area where the GPS can't work.

Conclusion and Benefits Drivers' Benefits:

Reduced driving time spent searching for parking.

Reduced traffic congestion.

Parking availability ensured at trip destination.

Pre-trip parking information.

Future option for a pre-trip or during trip parking reservation.

Parking Sector:

Parking occupancy enhanced.

Additional service to customers.

Better management control.

Municipalities:

Reduced searching for parking by drivers.

Reduced traffic congestion.

Reduced pollution.

Better control of parking spaces.

New source of income.

### BRIEF DESCRIPTION OF THE DRAWINGS

A better understanding of the present invention may be obtained by reference to the accompanying drawings, which should be considered in conjunction with the detailed description, all in accordance with the present invention.

FIG. 1 is an illustration of the Parking Detector floating overlay display method in accordance with the present invention.

FIG. 2 is illustration of the parking detector as an application on a cellular phone in accordance with the present invention.

FIG. 3 is illustration of the parking detector on a car-navigation in accordance with the present invention.

FIG. 4 is an illustration of the parking detection system environment in accordance with the present invention.

FIG. 5 is a flow diagram of the parking detector. in accordance with the present invention.

### DESCRIPTION OF THE PREFERRED EMBODIMENT

In all the figures of the drawings, sub-features and integral parts that correspond to one another bear the same reference symbol.

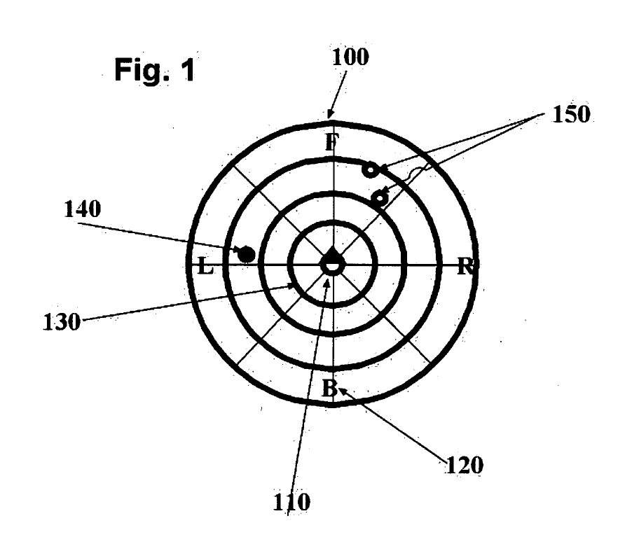

Referring now to the drawings in detail and first particularly to FIGS. 1-5 thereof.

These figures illustrate the method and system to detect and navigate to empty parking spaces utilizing our application on a cellular phone.

Referring to FIG. 1 This shows the real-time floating overlay omni-directional circular display, 100. This feature is superior to the GPS based systems and the existing mapping systems that are only accurate to within several hundred feet.

The user will have easy way to determine the distance and the direction to the available parking spaces without GPS or any mapping.

The available parking spaces will be displayed inside the graphical real-time omni-directional circular display in such way that the user will intuitively determine the distance and the direction to the empty parking spaces.

Each parking space will be shown with a simple color code to identify the type of the parking space e.g. 150 for example with green color will represent an empty regular parking space where 140 in color red for example will represent an empty handicap parking space.

Each color code display of an empty parking space can be accessed to obtain complete information about the available parking space e.g. price and automatic waypoint information.

Each circular line, 130, represents 50 feet in distance from the user's car. This makes it easy for the user to determine the distance to the available parking space.

Moreover to make it easy to understand the directions and determine the location of the available parking spaces 140 and 150, the circular display is divided into 4 parts represented as 120, B=behind the driving direction, 110 as the car's heading, R=to the right of the user's driving direction and L=to the left of the driving direction as well as F=forward of the user's car's heading.

Each of the empty parking spaces 140 and 150 are detected as a result of the broadcast directly from the parking sensor in an area of 300 feet around the user's car.

A very small RF sensor is installed in each parking space and in any place designated as parking space be it a parking meter, parking garage, street parking, inside or outside, public or commercial. The sensor can be RFID (long range type), a long range Bluetooth, a WIFI or any RF type. It broadcasts a unique ID by wireless that identifies the location of the parking space, 140 and 150, (unique parking ID, address, and price). The sensor recognizes a vacancy and broadcasts it to be picked up by the Parking Detector 100.

The overlay add-up device/display can work even without mapping at all, the VOR like add-up display will show the available parking spots in the immediate area without the need for a mapping background; mapping can be provided as an additional service. No regenerating of mapping is necessary.

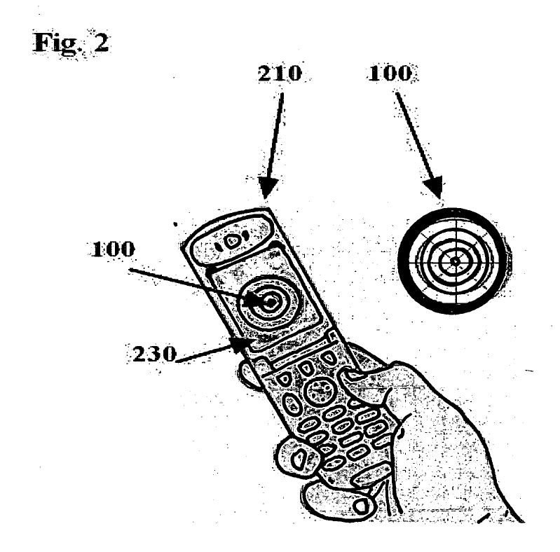

Referring to FIG. 2. This shows the floating overlay Parking Detector, 100, on a cellular phone, 210, as a Bluetooth cellular phone application; there is no need for cellular communication or any internet web communication or any central system nor any access to a database.

We utilize the cellular phone, 210, only as a Bluetooth enabled device and the application overlay floating circular display, 100, Parking Detector will run over either GPS existing mapping or over a background of an area floor plan, 230, that can be downloaded ahead of time, before accessing the parking area or downloaded via Bluetooth or WIFI upon arriving at the parking area.

Again, the mapping 230, or floor plan background is not critical to the navigation as the user will easily determine, locate and navigate to the empty parking spaces without the background mapping or the floor plan. Generation of mapping is not needed at all.

Moreover, by making the cellular phone, 210, a Parking Detector, even without any communication either cellular or internet, and using the telephone as a Bluetooth device, any user will be able to determine the empty spaces in the area, and use his telephone as Parking Detector, even though his car not equipped with built-in navigation.

It must be emphasized that there is a difference between using the cellular phone, 210 to receive information from the web or central database and our method where the cellular phone is used as our Parking Detector Bluetooth application that will receive information broadcast directly by the parking sensors. This information is available instantly without any requirement to request it.

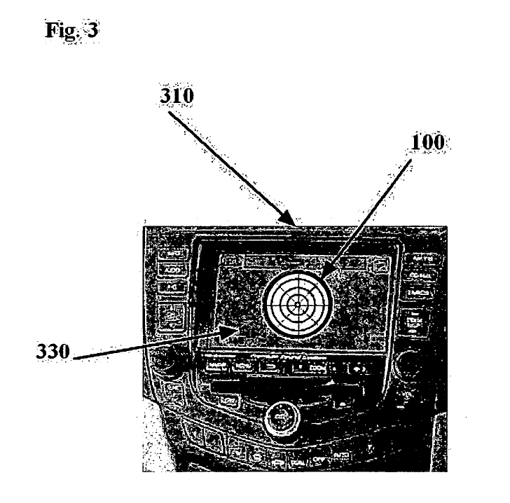

Turning now to FIG. 3. This figure shows the floating overlay Parking Detector, 100, on a car navigation system, 310, as an interface to the existing navigation system.

The floating overlay Parking Detector, 100, on the car navigation, 310, as a Bluetooth interface, there is no need for cellular communication, or any internet web communication or any central system nor any access to a database.

The overlay floating circular display, 100, Parking Detector will run over either GPS existing mapping or over a background of the area floor plan, 330, that can be downloaded ahead of time, before accessing the parking area or downloaded via Bluetooth or WIFI at upon arriving at the parking area.

either GPS existing mapping or over a background of an area floor plan 230 that can be downloaded ahead of time, before accessing the parking area or downloaded via Bluetooth or WIFI upon arriving at the parking area.

Again, the mapping 330, or floor plan background are not critical to the navigation as the user will easily determine, locate and navigate to the empty parking spaces without the background mapping or

the floor plan. Generation of mapping is not needed at all.

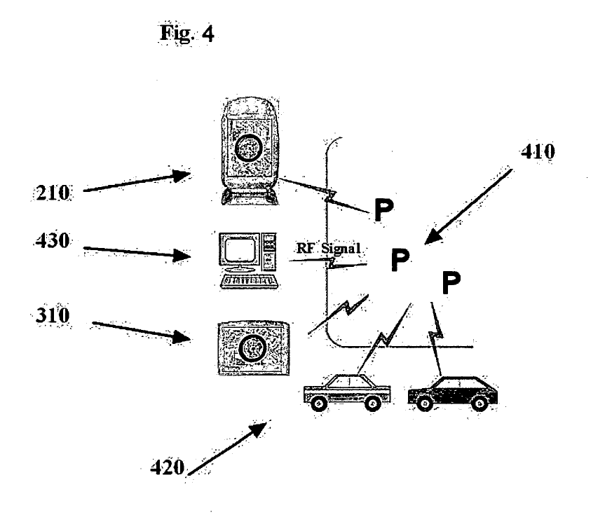

Referring to FIG. 4. This figure shows an illustration of the entire detection system including the parking sensors, 410, the sensors 410, an RF motion sensor network that detects the available parking space.

A very small RF sensor installed in each parking space, and in any place designated as parking space be it a parking meter, parking garage, street parking, inside or outside, public or commercial. The sensor can be RFID (long range type), a long range Bluetooth, a WIFI or any RF type. It broadcasts a unique ID by wireless that identifies the location of the parking space (unique parking ID, address, and price). The sensor recognizes a vacancy and broadcasts it to be picked up by the Parking Detector application on either cellular phone, 210, or car navigation, 310, or in-car 420 navigation system. The system can generate a parking ticket (e.g. in a parking garage) with the exact location of an available parking space.

Additional information screens can be installed at the corners of parking lines, guiding drivers to locate available parking space. These lens/screens can be installed on street corners, or in open parking garages or on parking meters to provide extra assistance to drivers.

Our solution is designed for global use and is not limited to parking garage or parking metered spaces, our innovation can be implemented anywhere, in any place designated as parking space . . . !

It is our plan that in the future all new construction designated for parking spaces will have the sensor tags included in the design.

With our innovation, the next generation parking meter can be . . . no meter at all, with automatic recognition and automatic payments.

The ability to make “Remote” reservations will be future option.

We integrated the parking system as part of our NAV4 concepts where it will provide complete solutions for local navigation in an area where the GPS can't work.

Our Bluetooth/RF sensor 410 is based on a long range version of the popular short distance communication. This unique feature affords the user the ability to plan ahead where to park by obtaining data directly from the parking sensors and from remote by accessing the inventory of available parking spaces at the destination from data broadcast by Parking Guide 430.

Or the parking data can be displayed as a clear, heads-up display on the windshield of the driver's car 420 for the next generation parking detector.

More over, our innovation can solve the “RTP” (Return to parking) problem, where many forget where they parked their car. The system has an option to save the location on the “cellular phone—Parking Detector” application, that will make it easy to locate the parked car.

The parking sensors 410 broadcast their signal continuously and any of our parking detectors 210 or 310 will detect them and display the data on the “user” device in an easy to understand method.

With our innovation you have the parking information that you want, when you want it, where you want it . . . (and at a price you can afford . . . ).

Once you are in the vicinity of your destination and switch on the Parking Detector, you will automatically receive the parking information along your route (in all directions around you).

No further action is required (there is no need to send a request or to access the internet/web or log on and search a database or central system . . . !!!).

Our unique approach does not need an internet bandwidth or cellular communication at all.

And as a result there is no delay or waiting for communication and access time, the communication is instantaneous, directly between the sensors 410 and the user's Parking Detector either 210 or 310.

Parking Detector.

Empty parking spaces will be displayed inside a graphical real-time floating omni-directional circular display in such way that the user 420 will intuitively determine the distance and the direction to the empty parking spaces.

Any Bluetooth enabled device can serve as a parking detector using our application method and this is not limited to cellular phone 210 and or in-car navigation 310.

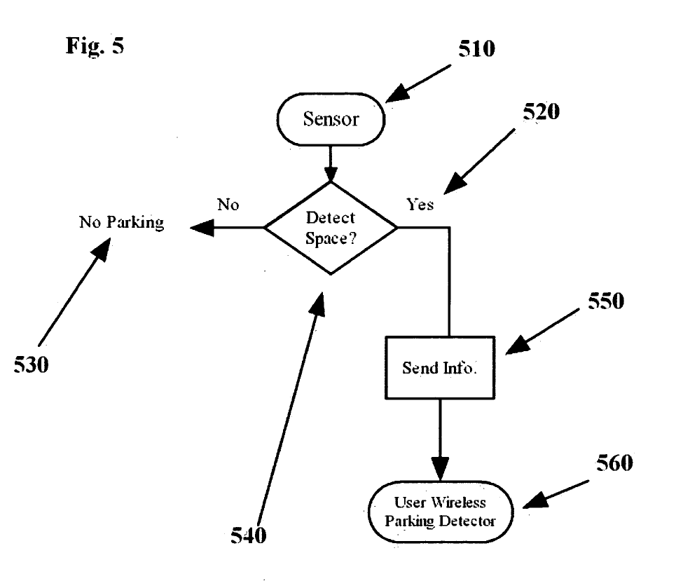

Turning to FIG. 5. This figure shows the method of broadcasting the empty parking space information to the Parking Detectors in the area.

The RF sensor 510 will detect 540 the empty parking space and only then 520 will broadcast 550 to the parking detectors 560. If a space is occupied, 530, then nothing is broadcast at all.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A wireless Parking Detector, comprising:
A radio frequency (RF) sensor for detecting an empty parking space and outputting parking data; and
A transmitter receiving the parking data from said RF sensor and wirelessly transmitting the parking data.

2. The wireless Parking Detector according to claim 1, wherein said transmitter transmitting only when said RF sensor detects an actually empty parking space.

3. The wireless Parking Detector according to claim 1, wherein said RF sensor is one of a plurality of wireless sensors defining a network where each of said wireless sensors detects a designated, individual parking space.

4. The wireless Parking Detector according to claim 1, wherein said RF sensor can be installed on any place that is designated as a parking space.

5. The wireless sensor according to claim 1, wherein the parking data includes a data ID of a particular parking space.

6. The wireless sensor according to claim 5, wherein the parking data includes address data, price data, and type of parking data selected from the group consisting normal parking and handicap parking.

7. A method for displaying parking availability information on at least one display device selected from the group consisting of a vehicle on-board navigation system, a mobile phone, and a Bluetooth enabled device, the method comprises the steps of:
Receiving parking space data from a parking sensor, the parking space data including positional data, price data, and type of parking availability data selected from the group consisting of normal parking and handicap parking; and
displaying empty parking space information as a floating overlay on the display device.

8. The method according to claim 7, which further comprises floating the empty parking space information over an existing floor plan.

9. The method according to claim 7, wherein the empty parking space information is displayed as a stand alone application without background mapping.

10. The method according to claim 7, which further comprises displaying the empty parking space information over a facility map, area map, or floor plan downloaded to the display device.

11. The method according to claim 7, wherein the empty parking space information pertains to navigating a current parking area.

12. The method according to claim 11, which further comprises determining a current position of a vehicle by a triangulation calculation based on known positions of a plurality of wireless parking sensors detecting the vehicle.

13. The method according to claim 12, which further comprises navigating to the current parking area using a mapping facility.

14. The method according to claim 7, which further comprises producing a parking ticket with an exact location to a parking space for a vehicle, the parking ticket being distributed by a parking garage.

15. The method according to claim 7, which further comprises electronically paying the parking fee per the parking sensor which replaces a parking meter.

16. The method according to claim 7, wherein the parking sensor automatically debits the amount of the parking fee against the account of the user of the display device.

17. The method according to claim 12, which further comprises performing the determining step without the aid of a global positioning satellite system.

18. The method according to claim 7, which further comprises:
Registering an exact parking place location of a vehicle on the display device; and
Subsequently retrieving the exact parking place location for determining where the vehicle is parked.

19. The method according to claim 18, which further comprises displaying on the display device a mapping between a current position and the exact parking place location of the vehicle.

20. The method according to claim 7, which further comprises displaying additional information of an available parking space as a waypoint.

21. The method according to claim 7, which further comprises providing the display device with an omni directional circular display.

22. The method according to claim 7, which further comprises forming the display device as a head-up display device projecting onto a vehicle windshield and displaying the empty parking space information via the head-up device.

23. The method according to claim 21, which further comprises determining a distance and direction to an empty parking space with the omni directional circular display.

24. The method according to claim 7, which further comprises providing the display device with application software for displaying pre-loaded area maps or parking facility floor plans.
